(19) United States
(12) Patent Application Publication
(10) Pub. No.: US 2010/0036798 A1
(43) Pub. Date: Feb. 11, 2010

(54) SYSTEM AND METHOD OF ACCESSING DRM FILES AND NON-DRM FILES IN A MOBILE DEVICE

(75) Inventor: LI-JUNG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/346,876

(22) Filed: Dec. 31, 2008

(30) Foreign Application Priority Data
Aug. 8, 2008 (CN) 200810303586.3

(51) Int. Cl. G06F 17/30

(52) U.S. Cl. 707/1; 707/E17.001; 707/E17.01

(57) ABSTRACT

A method of accessing digital rights management (DRM) files and non-DRM files in a mobile device includes providing an intermediate interface between one or more application modules of the mobile device and a file system of the mobile device, and providing a DRM module between the intermediate interface and the file system. The method further includes determining if the file is controlled by DRM through the intermediate interface when a selected application module sends a file request to the file system to access the file, processing the file request using the DRM module to verify if the file is controlled by DRM, and returning a processed result to the selected application module.

### BACKGROUND

1. Field of the Invention

Embodiments of the present disclosure relate to systems and methods for managing files, and particularly to a system and method of accessing digital rights management (DRM) files and non-DRM files in a mobile device.

2. Description of Related Art

Mobile phones can be used to exchange digital content (e.g., MP3 files downloaded from the Internet) and communicate with each other almost anytime and anywhere. However, some digital content is encapsulated in a DRM shell in order to prevent unauthorized forwarding and/or downloading of digital content from one mobile device to another. However, opening and processing selected files with DRM and without DRM can be very inconvenient and convoluted.

### BRIEF DESCRIPTION OF THE DRAWINGS

FIG. 1 is a schematic diagram of one embodiment of a mobile device comprising a module system to access a file using a DRM module;

FIG. 2 is a block diagram of one embodiment of an intermediate interface shown in FIG. 1; and

FIG. 3 is a flowchart of one embodiment of opening a file by an intermediate interface shown in FIG. 1.

### DETAILED DESCRIPTION OF CERTAIN INVENTIVE EMBODIMENTS

All of the processes described below may be embodied in, and fully automated via, software code modules executed by one or more general purpose mobile devices or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

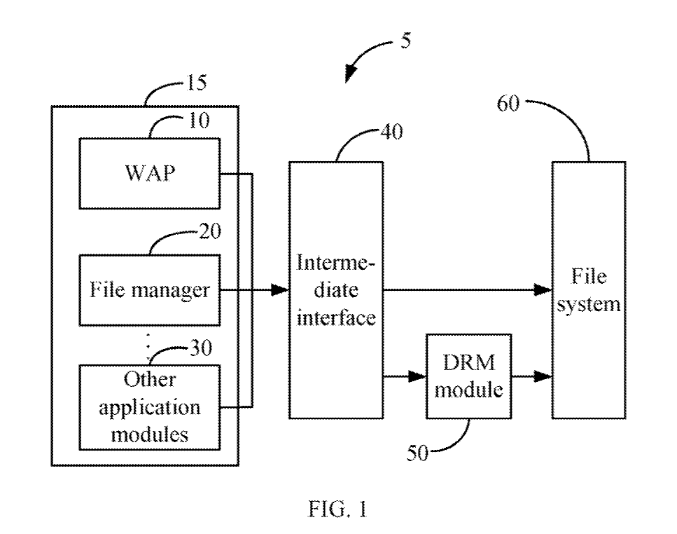

FIG. 1 is a schematic diagram of one embodiment of a mobile device 5 comprising a module system 15 to access a file using a DRM module 50. In one embodiment, the module system 15 comprises a WAP 10, a file manager 20, and other application modules 30 communicating with the DRM module 50 and a file system 60 via an intermediate interface 40. The intermediate interface 40 is positioned between the module system 15 and the file system 60, and the DRM module 50 is positioned between the intermediate interface 40 and the file system 60.

The intermediate interface 40 is configured for determining if a file is controlled by DRM when an application module from the module system 15 sends a file request to the file system 60 to access the file. The intermediate interface 40 verifies if the file is controlled by DRM using the DRM module 50 and returns a processed result to the application module. In one embodiment, the processing of the file request includes: obtaining a path of the file, obtaining a size of the file, opening the file, and closing the file.

The DRM module 50 is configured for parsing a file, encrypting a file, and decrypting a file. In one embodiment, the mobile device may be a cell phone, a digital camera, or a personal digital assistant (PDA).

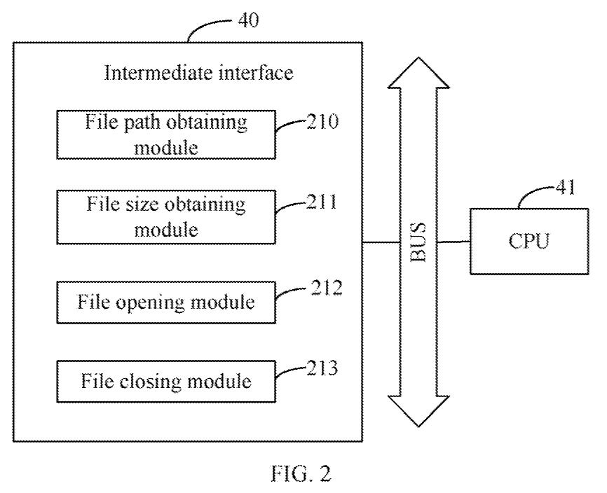

FIG. 2 is a block diagram of one embodiment of the intermediate interface 40 shown in FIG. 1. In one embodiment, the intermediate interface 40 includes a file path obtaining module 210, a file size obtaining module 211, a file opening module 212, and a file closing module 213. In one embodiment, a processor 41 is connected with the intermediate interface 40 via a data bus and is used to execute one or more operations for the modules 210, 211, 212, and 213.

The file path obtaining module 210 is configured for obtaining a path of a file. The file size obtaining module 211 is configured for obtaining a size of the file, for example, by executing a function of “int drmGetFileSize(handle).” It may be understood that the “handle” stands for a file handle, such as an identifier to differentiate each file. It may be further understood that “int” refers to an integer value of the result of the drmGetFileSize( ) function, but the disclose is not limited thereto. Other values, such as floating point values and long values may also be used.

The file opening module 212 is configured for determining if the file is protected by DRM, determining if file content is encrypted, and opening the file. Opening the file, in one embodiment, may be done by executing a function of “handle drmOpenFile(char*uri)”. The “uri” stands for the path of the file needed to be opened. The file closing module 213 is configured for closing the file, for example, by executing a function of “void drmCloseFile(handle)”.

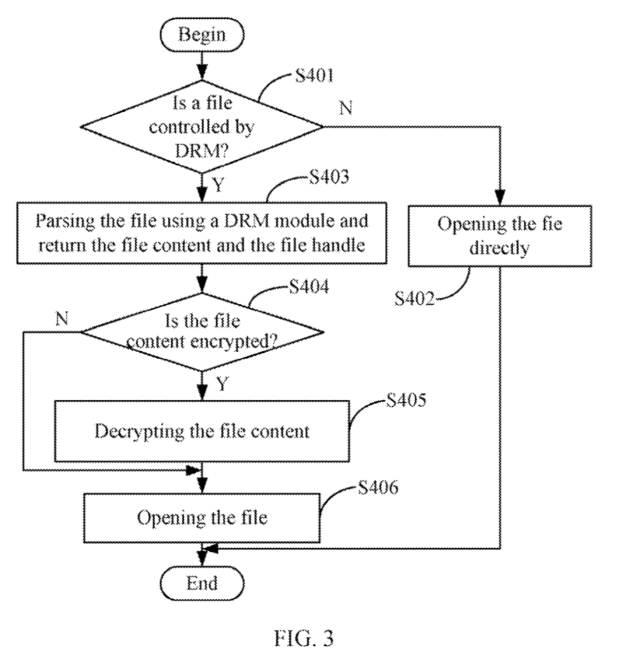

FIG. 3 is a flowchart of one embodiment of opening a file by the intermediate interface 40 shown in FIG. 1. Depending on the embodiment, additional blocks may be added, others removed, and the ordering of the blocks may be changed. In one exemplary embodiment, the file may be a MP3 file controlled by DRM or a Microsoft Word document without DRM.

In block S401, the file opening module 212 determines if the file is controlled by DRM (e.g., the MP3 file) when an application module sends a file request to the file system 60 to access the file. If the file is not protected by DRM (e.g., the Microsoft Word document), the process goes to block S402, where the file opening module 212 opens the file directly and the process ends. Otherwise, if the file is protected by DRM, the process goes to block S403. Since the MP3 file is controlled by DRM, the flow moves to block S403.

In block S403, the file opening module 212 parses the MP3 file using the DRM module 50 and returns the file content and the file handle, then the process goes to block S404.

In block S404, the file opening module 212 determines if the file content of the MP3 file is encrypted. If the file content of the MP3 file is encrypted, the process goes to block S405, or if the file content is not encrypted, the process directly goes to block S406.

In block S405, the file opening module 212 decrypts the file content using the DRM module 50, then the process goes to block S406.

In block S406, the file opening module 212 opens the MP3 file.

The present embodiment provides a single interface to access files allowing for an easy way to access DRM and non-DRM files. File content requested by other application modules can be returned by the intermediate interface positioned between the file system and these application modules.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of accessing digital rights management (DRM) files and non-DRM files in a mobile device, the method comprising:
providing an intermediate interface between one or more application modules of the mobile device and a file system of the mobile device;
providing a DRM module between the intermediate interface and the file system;
determining if the file is controlled by DRM through the intermediate interface when a selected application module sends a file request to the file system to access the file; and
processing the file request using the DRM module to verify if the file is controlled by DRM, and returning a processed result to the selected application module.

2. The method according to claim 1, wherein the step of processing the file request comprises: obtaining a path of the file, obtaining a size of the file, opening the file, and closing the file.

3. The method according to claim 1, further comprising: opening the file directly if the file is not controlled by DRM.

4. The method according to claim 1, wherein the step of processing the file request using the DRM module comprises:
parsing the file using the DRM module and returning the file content and the file handle;
determining if the file content is encrypted; and
decrypting the file content and opening the file if the file content is encrypted, or opening the file directly if the file content is not encrypted.

5. The method according to claim 1, wherein the mobile device is selected from the group consisting of a cell phone, a digital camera, and a personal digital assistant (PDA).

6. A system of accessing digital rights management (DRM) files and non-DRM files in a mobile device, the mobile device comprising one or more application modules, a file system, and a DRM module, wherein:
an intermediate interface positioned between the one or more application modules and the file system, the DRM module positioned between the intermediate interface and the file system; and
wherein the intermediate interface is configured for determining if the file is controlled by DRM when a selected application module sends a file request to the file system to access the file, processing the file request using the DRM module to verify if the file is controlled by DRM, and returning a processed result to the selected application module.

7. The system according to claim 6, wherein the intermediate interface processes the file request comprises: obtaining a path of the file, obtaining a size of the file, opening the file, and closing the file.

8. The system according to claim 6, wherein the intermediate interface is further configured for opening the file directly if the file is not controlled by DRM.

9. The system according to claim 6, wherein the intermediate interface processes the file request using the DRM module comprises:
parsing the file using the DRM module and returning the file content and the file handle;
determining if the file content is encrypted; and
decrypting the file content and opening the file if the file content is encrypted, or opening the file directly if the file content is not encrypted.

10. The system according to claim 6, wherein the mobile device is selected from the group consisting of a cell phone, a digital camera, and a personal digital assistant (PDA).
